(19) United States
(12) Patent Application Publication
(10) Pub. No.: US 2009/0293058 A1
(43) Pub. Date: Nov. 26, 2009

(54) VIRTUAL SYSTEM AND METHOD OF RESTRICTING USE OF CONTENTS IN THE VIRTUAL SYSTEM

(75) Inventors: Chang-sup AHN, Seoul (KR); Jun-bum SHIN, Suwon-si (KR); Sang-bum SUH, Seoul (KR); Sung-min LEE, Suwon-si (KR); Kyung-ah CHANG, Seoul (KR); Moon-young CHOI, Seoul (KR); Yang-lim CHOI, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/413,621

(22) Filed: Mar. 30, 2009

(30) Foreign Application Priority Data
May 22, 2008 (KR) 10-2008-0047744

(51) Int. Cl. G06F 9/455

(52) U.S. Cl. 718/1

(57) ABSTRACT

Provided is a method of restricting use of contents in a virtual system comprising at least one virtual machine implemented by applying virtualization technology to a predetermined device. The method includes: reading a first device identifier from the device in order to identify the device; reading a second device identifier, which is a device identifier allocated to the at least one virtual machine, from the at least one virtual machine; determining whether the first device identifier is identical to the second device identifier; and selectively restricting use of contents in the at least one virtual machine based on a result of the determining.

### CROSS-REFERENCE TO RELATED PATENT APPLICATION

This application claims priority from Korean Patent Application No. 10-2008-0047744, filed on May 22, 2008, in the Korean Intellectual Property Office, the disclosure of which is incorporated herein in its entirety by reference.

### BACKGROUND OF THE INVENTION

1. Field of the Invention

The present invention relates to a virtual system and a method of restricting use of contents in the virtual system.

2. Description of the Related Art

Virtualization technology is a way of independently running multiple operating systems in a single physical device. In virtualization technology, the physical device does not directly execute command codes of an application. Instead, at least one virtual machine implemented in the physical device interprets and executes the command codes. Such virtualization technology has been used in the fields of mass storage servers and have been recently applied to personal computers (PCs), personal digital assistants (PDAs), Consumer Electronics (CE), and the like.

In addition, as digital contents become more widely used, efforts to prevent unauthorized distribution and use of digital contents have been implemented using Digital Rights Management (DRM). DRM may also be applied to a virtual system embodied by virtualization technology.

FIG. 1 shows a related art virtual system to which DRM is applied.

FIG. 1 shows a migration of a virtual machine of a first virtual system 110 to a second virtual system 120.

Referring to FIG. 1, the first virtual system 110 includes a virtual machine (indicated by dashed lines) which includes an operating system 116 and DRM software 118, and the second virtual system 120 includes a virtual machine (indicated by dashed lines) which includes an operating system 126 and DRM software 128.

Migration is a process of storing a virtual machine implemented in the first virtual system 110 as an image file and implementing a virtual machine, which is the same as the virtual machine of the first virtual system 110, in the second virtual system 120 using the stored image file.

Hereinafter, assuming that a first hardware unit 112 of the first virtual system 110 is an authorized device, and a second hardware unit 122 of the second virtual system 120 is an unauthorized device, operations of the DRM software 118 of the first virtual system 110 and the DRM software 128 of the second virtual system 120 will be described.

First, when a virtual machine including the operating system 116 and the DRM software 118 is implemented in the first virtual system 110 using virtualization technology, a virtual machine manager 114 allocates DEVICE ID=“1234” of the first hardware unit 112 to the operating system 116.

Next, when the DRM software 118 requests a DEVICE ID from the operating system 116, the operating system 116 transmits the allocated DEVICE ID=“1234” to the DRM software 118. Then, the DRM software 118 allows the contents to be used in the operating system 116 since the DEVICE ID=“1234” is an authorized DEVICE ID.

Since the virtual machine of the first virtual system 110 is migrated to the second virtual system 120, the DEVICE ID=“1234” is allocated to the operating system 126. Thus, the virtual machine manager 124 does not allocate another DEVICE ID to the operating system 126. That is, a DEVICE ID of the first hardware unit 112, rather than a DEVICE ID of the second hardware 122, is allocated to the operating system 126.

In this situation, when the DRM software 128 requests a DEVICE ID from the operating system 126, the operating system 126 transmits the allocated DEVICE ID=“1234” to the DRM software 128.

Since DEVICE ID=“1234” is an authorized DEVICE ID, the DRM software 128 determines that the virtual machine is authorized even though the virtual machine is implemented in the unauthorized device of the second hardware 122. Thus, the DRM software 128 does not restrict the use of contents in the operating system 126.

Therefore, related art DRM software cannot restrict unauthorized use of contents in a virtual machine implemented in an unauthorized device.

### SUMMARY OF THE INVENTION

The present invention provides a method of restricting use of contents in a virtual system in order to restrict use of contents in a virtual machine implemented in an unauthorized device and a virtual system manufactured using the method.

According to an aspect of the present invention, there is provided a method of restricting use of contents in a virtual system comprising at least one virtual machine implemented by a device, the method comprising: reading a first device identifier from the device in order to identify the device; reading a second device identifier, which is a device identifier allocated to the at least one virtual machine, from the at least one virtual machine; determining whether the first device identifier is identical to the second device identifier; and selectively restricting use of contents in the at least one virtual machine based on a result of the determining.

The virtual system may comprise: at least one virtual machine comprising an operating system and a use control unit suitable to selectively restrict use of contents executed in the operating system; and a virtual machine managing unit for managing the at least one virtual machine, wherein the second device identifier is allocated to the operating system of the at least one virtual machine.

The virtual machine managing unit may be installed in the at least one virtual machine or in a separate virtual machine which does not comprise the operating system and the use control unit.

The second device identifier may be an identifier of the device which is allocated to the virtual machine before reading the first device identifier or an identifier of another device.

The restricting of use of contents may comprise: generating a status flag which represents a possibility of the use of contents based on the result of the determining; and selectively restricting the use of contents in the at least one virtual machine based on the status flag.

The restricting of use of contents may comprise: an operation in which the virtual machine managing unit selectively transmits the read second device identifier to the use control unit based on the result of the determining; and an operation in which the use control unit selectively restricts the use of contents in the at least one virtual machine depending on whether the second device identifier is transmitted.

The restricting of use of contents may comprise: if a virtual machine is being newly operated in the device for the first time, determining whether the second device identifier is allocated to the use control unit of the newly operated virtual machine; comparing whether the second device identifier allocated to the use control unit is identical to the first device identifier if it is determined that the second device identifier is allocated to the use control unit; and selectively restricting operations of the operating system of the newly operated virtual machine according to the result of the comparing.

The restricting of use of contents may comprise: periodically determining whether the second device identifier is allocated to the use control unit of the at least one virtual machine; comparing the second device identifier allocated to the use control unit with the first device identifier if it is determined that the second device identifier is allocated to the use control unit; and selectively restricting the use of contents in the at least one virtual machine based on the result of the comparing.

The virtual machine further may comprise at least one selected from the group consisting of user authentication information used to authenticate user who wants to use contents executed in the virtual machine, use restriction information for restricting the use of contents, and integrity validation information for detecting tampering with regard to the user authentication information and the use restriction information.

The method may further comprise: detecting tampering with regard to the user authentication information and the use restriction information based on the integrity validation information; and performing authentication of the user based on the user authentication information if it is determined that the user authentication information and the use restriction information are not tampered, wherein the selective restricting of use of contents is performed based on a result of the authentication and the use restriction information.

According to another aspect of the present invention, there is provided a virtual system for restricting use of contents in at least one virtual machine implemented by a device, the virtual system comprising: at lest one virtual machine comprising an operating system and a use control unit selectively restrict use of contents executed in the operating system; and a virtual machine managing unit for managing the at least one virtual machine, wherein the virtual machine managing unit reads a first device identifier from the device in order to identify the device, reads a second device identifier allocated to the at least one virtual machine from the at least one virtual machine, determines whether the first device identifier is identical to the second device identifier, and controls the use control unit to selectively restrict the use of contents in the at least one virtual machine based on the result of the determination.

According to another aspect of the present invention, there is provided a computer-readable recording medium in which a program for implementing a method of restricting use of contents in a virtual system comprising at least one virtual machine implemented by a device, the method comprising: reading a first device identifier from the device in order to identify the device; reading a second device identifier, which is a device identifier allocated to the at least one virtual machine, from the at least one virtual machine; determining whether the first device identifier is identical to the second device identifier; and selectively restricting use of contents in the at least one virtual machine based on the result of the determining.

### BRIEF DESCRIPTION OF THE DRAWINGS

The above and other aspects of the present invention will become more apparent by describing in detail exemplary embodiments thereof with reference to the attached drawings in which:

FIG. 1 shows a related art virtual system to which DRM is applied;

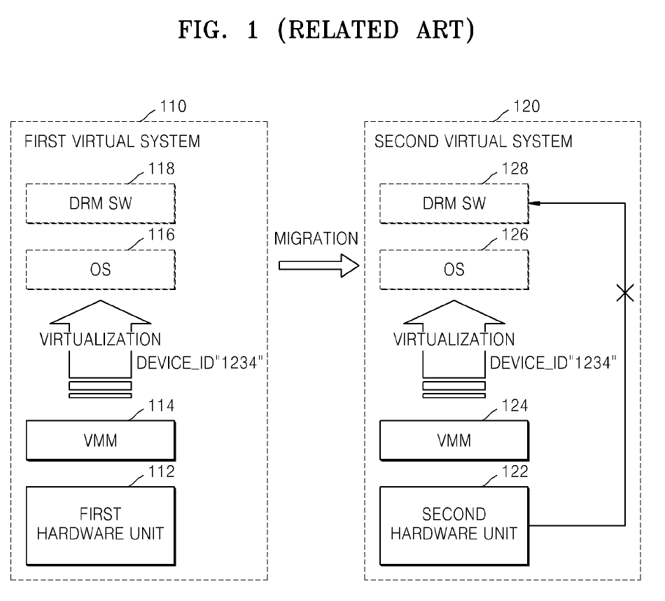

FIG. 2 shows a virtual system for restricting use of contents in a virtual machine according an exemplary embodiment of the present invention;

FIG. 3 shows a virtual system for restricting use of contents in a virtual machine according another exemplary embodiment of the present invention;

FIG. 4 shows a virtual system for restricting use of contents in a virtual machine according another exemplary embodiment of the present invention; and

FIG. 5 is a flowchart illustrating a method of restricting use of contents in a virtual system according to an exemplary embodiment of the present invention

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

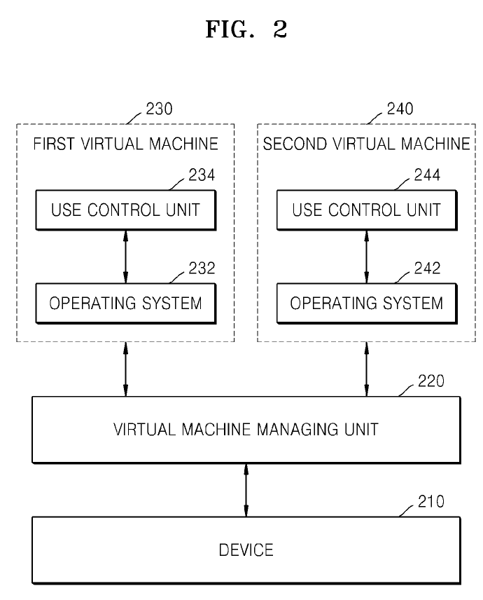

FIG. 2 shows a virtual system for restricting use of contents in a virtual machine according an exemplary embodiment of the present invention.

Referring to FIG. 2, a virtual system according to the present invention includes a device 210, a virtual machine managing unit 220, a first virtual machine 230, and a second virtual machine 240. However, the virtual system may also include multiple virtual machines in addition to the first virtual machine 230 and the second virtual machine 240.

The device 210 is physical hardware which is a basis for implementing a virtual machine such as the first virtual machine 230 and the second virtual machine 240 using virtualization technology. For example, the device 210 may be a laptop computer, a PC, a portable multimedia player (PMP), and the like.

The virtual machine managing unit 220 manages the first virtual machine 230 and the second virtual machine 240.

The first virtual machine 230 includes an operating system 232 and a use control unit 234.

The operating system 232 is software for controlling and managing operations of the device 210. In this regard, the operating system 232 may control the device 210 through the virtual machine managing unit 220.

The use control unit 234 selectively restricts use of contents executed in the operating system 232. If the device 210 is an unauthorized device, the use control unit 234 selectively restricts the use of contents executed in the operating system 232. Here, the use of contents includes execution, copying, and deleting of the contents.

Here, the use control unit 234 may be DRM software, but is not limited thereto. The use control unit 234 may also be any software used to control the use of contents executed in the operating system 232.

The second virtual machine 240 also includes an operating system 242 and a use control unit 244. Since functions of the operating system 242 and the use control unit 244 of the second virtual machine 240 are the same as those of the operating system 232 and the use control unit 234 of the first virtual machine 232, description thereof will be omitted.

Operation of the virtual system according to an exemplary embodiment of the present invention will be described with reference to FIG. 2.

First, when power is applied to the virtual system, the virtual machine managing unit 220 reads a first device identifier from the device 210 in order to identify the device 210. The first device identifier may be a device key, a device serial number, a specific memory address, or the like stored in an electrically erasable programmable read-only memory (EEPROM) of the device 210.

Next, the virtual machine managing unit 220 reads second device identifiers, which are device identifiers respectively allocated to each of the virtual machines 230 and 240, from the virtual machines 230 and 240. Here, the second device identifiers are generally allocated to the operating systems 232 and 242.

As described above, when the first and second virtual machines 230 and 240 are operated in the current device 210, the first device identifier, which is a device identifier of the current device 210, is allocated to the virtual machines 230 and 240 as the second device identifier. However, when the first and second virtual machines 230 and 240 are migrated from another device (not shown), a device identifier of another device is allocated to the migrated first and second virtual machines 230 and 240 as the second device identifier.

If the virtual machine is being newly operated in the device 210 for the first time, the second device identifier may not be allocated to the virtual machines 230 and 240. For example, if the first virtual machine 230 is newly operated in the device 210, the second device identifier is not previously allocated to the first virtual machine 230. In this case, the virtual machine managing unit 220 allocates the first device identifier read from the device 210 to the first virtual machine 230 as the second device identifier.

As described above, if the second device identifier is allocated to the first virtual machine 230, the virtual machine managing unit 220 may read the second device identifier from the first virtual machine 230.

However, according to another exemplary embodiment, if the second device identifier is not allocated to the first virtual machine 230, the virtual machine managing unit 220 may allocate the second device identifier to the first virtual machine 230 and allow use of contents executed in the first virtual machine 230 without performing an additional process. This is because it is clear that the first virtual machine 230 is not a migrated virtual machine. Meanwhile, if the first device identifier and the second device identifier are read as described above, the virtual machine managing unit 220 compares the first device identifier to the second device identifier to determine whether they are identical and transfers the result of the comparison to the use control units 234 and 244 of the virtual machines 230 and 240.

Here, the virtual machine managing unit 220 generates a status flag which indicates whether contents can be used and transmits the status flag to the use control unit 234 of the virtual machine 230 and the use control unit 244 of the virtual machine 240. That is, the virtual machine managing unit 220 transmits a status flag of “ENABLE” to the use control units 234 and 244 when the first device identifier is identical to the second device identifier, and transmits a status flag of “DISABLE” to the use control units 234 and 244 when the first device identifier is not identical to the second device identifier.

For example, if the second device identifier allocated to the first virtual machine 230 is not identical to the first device identifier read from the current device 210, the first virtual machine 230 may be regarded as a migrated virtual machine, and thus the virtual machine managing unit 220 transmits the status flag of “DISABLE” to the use control unit 234 of the first virtual machine 230.

Only when the status flag received from the virtual machine managing unit 220 is “ENABLE”, the use control unit 234 of the first virtual machine 230 allows the use of contents executed in the operating system 232 of the first virtual machine 230.

In addition, the virtual machine managing unit 220 may selectively transmit the second device identifier read from the operating systems 232 and 242 of the virtual machines 230 and 240 to each of the use control units 230 and 240 based on the results of comparison. That is, the use control units 234 and 244 cannot obtain the second device identifier directly from the operating systems 232 and 242 of the virtual machines 230 and 240, but can only obtain the second device identifier from the virtual machine managing unit 220 or from the operating systems 232 and 242 through a control of the virtual machine managing unit 220.

For example, the virtual machine managing unit 220 does not transmit the second device identifier to the use control unit 234 of the first virtual machine 230 if the second device identifier allocated to the operating system 232 of the first virtual machine 230 is not identical to the first device identifier. The virtual machine managing unit 220 transmits the second device identifier to the use control unit 234 of the first virtual machine 230 if the second device identifier allocated to the operating system 232 of the first virtual machine 230 is identical to the first device identifier.

In this regard, the use control unit 234 of the first virtual machine 230 allows the use of contents executed in the operating system 232 of the first virtual machine 230 only when the use control unit 234 receives the second device identifier from the virtual machine managing unit 220.

The first and second virtual machines 230 and 240 may further include user authentication information, use restriction information for controlling use of contents, integrity validation information for detecting tampering with regard to the user authentication information and the use restriction information. In this regard, the user authentication information may be the ID and password of a qualified user, and the integrity validation information may be a Hash value, message authentication code, or electronic signature of the user authentication information and the use restriction information.

If the first virtual machine 230 has a configuration as described above, the virtual machine managing unit 220 detects whether the user authentication information and the use restriction information are tampered based on the integrity validation information included in the first virtual machine 230. If the user authentication information and the use restriction information are not tampered, the user authentication may be performed based on the user authentication information.

When the user authentication is completed, the virtual machine managing unit 220 transmits the result of the authentication to the use control unit 234 of the first virtual machine 230 and the use control unit 234 restricts the use of contents in the first virtual machine 230 based on received result. In this regard, the use control unit 234 of the first virtual machine 230 can determine whether to allow the use of contents by not only considering the authentication result but also the result of the comparison between the second device identifier allocated to the first virtual machine 230 and the first device identifier read from the device 210.

For example, the use control unit 234 of the first virtual machine 230 allows use of contents in the first virtual machine 230 only when the second device identifier is identical to the first device identifier and the authentication result indicates that the user is qualified. Even if the first device identifier is not identical to the second device identifier, use of contents may be allowed in the first virtual machine 230 if it is determined through the authentication that the user who wants to use the contents executed in the first virtual machine 230 is qualified to do so. The allowance of the use of contents may be determined according to the content use policy set up in the use control unit 234.

The use of contents may be restricted by use restriction information even in the case where the use of contents is allowed by the use control unit 234 of the first virtual machine 230. For example, if the use restriction information restricts the number of playback times of contents or the number of copying times of contents, the use of contents may be allowed within the number limit of the content use.

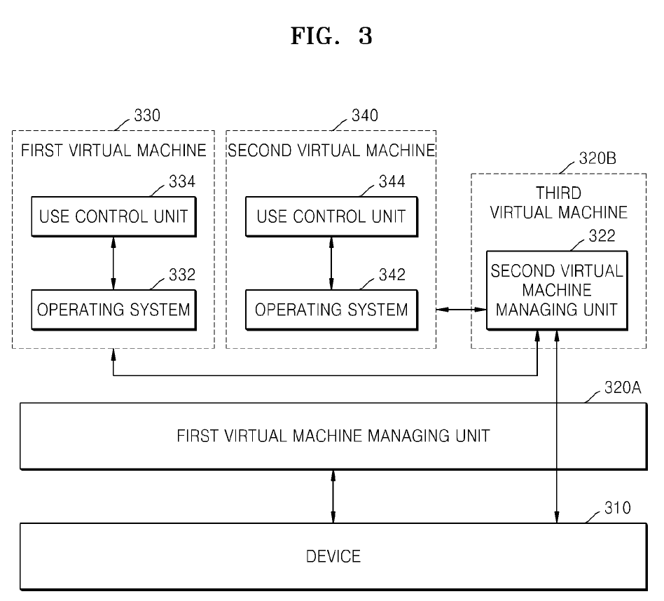

FIG. 3 shows a virtual system for restricting use of contents in a virtual machine according another exemplary embodiment of the present invention.

A virtual machine managing unit of FIG. 3 which is distinguished from the virtual machine managing unit 220 of FIG. 2 is divided into a first virtual machine managing unit 320A and a second virtual machine managing unit 322, and a third virtual machine 320B may include a second virtual machine managing unit 322 in a virtual system based on Xen as shown in FIG. 3. In this regard, the first virtual machine managing unit 320A only performs functions of managing the first virtual machine 330 and the second virtual machine 340 among the functions of the virtual machine managing unit 220 of FIG. 2, and the second virtual machine managing unit 322 performs operations required to restrict the use of contents.

That is, the second virtual machine managing unit 322 reads a first device identifier from a device 310, reads a second device identifier allocated to each of virtual machines 330 and 340 from the virtual machines 330 and 340, and determines whether the read first device identifier is identical to the read second device identifier. In addition, the second virtual machine managing unit 322 transmits the result of the comparison to the use control units 334 and 344 of each of the virtual machines 330 and 340.

In the virtual system described above, the second device identifier is allocated to operating systems 332 and 342 of each of the virtual machines 330 and 340. However, the second device identifier may be allocated to the use control units 334 and 344.

If the second device identifier is allocated to the use control units 334 and 344, the use control units 334 and 344 may determine that the device 310 is qualified and allow the use of contents executed in the operating systems 332 and 342 of each of the virtual machines 330 and 340 even though the use control units 334 and 344 do not receive the result of the comparison from the second virtual machine managing unit 322.

Since such a problem may occur, the virtual machine needs to be configured such that the second device identifier is fundamentally not allocated to the use control unit 334 of the virtual machine 330 and the use control unit 344 of the virtual machine 340.

However, if the second device identifier is inevitably allocated to the use control unit 334 of the virtual machine 330 and the use control unit 344 of the virtual machine 340, there is a need to develop a solution that prevents the problem.

In order to prevent the problem, a method of restricting the use of contents in the virtual machines 330 and 340 according to an exemplary embodiment of the present invention is introduced. The method includes checking whether the second device identifier is allocated to the use control unit 334 of the virtual machine 330 and the use control unit 344 of the virtual machine 340, and comparing whether the second device identifier allocated to the use control units 334 and 344 is identical to the first device identifier of the device 310, if allocated.

For example, when the first virtual machine 330 is newly operated for the first time, the second virtual machine managing unit 322 checks whether the second device identifier is allocated to the use control unit 334 of the newly operated first virtual machine 330. If the second device identifier is allocated to the use control unit 334 of the first virtual machine 330, the virtual machine managing unit 322 transmits the result of the comparison on whether the allocated second device identifier is identical to the first device identifier of the device 310 to the use control unit 334, and the use control unit 334 may selectively restrict the use of contents executed in the first virtual machine 330 based on the result of the comparison. In this regard, the second virtual machine managing unit 322 may not only restrict the use of contents executed in the operating system 332 of the first virtual machine 330, but also inhibit operation of the operating system 332.

Furthermore, the second virtual machine managing unit 322 may also periodically check whether the second device identifier is allocated to the use control unit 334 of the virtual machine 330 and the use control unit 344 of the virtual machine 340 in addition to when the virtual machine is being newly operated for the first time.

Meanwhile, the second virtual machine managing unit 322 and the use control units 334 and 344 may be operated in the same manner as the virtual machine managing unit 220 and the use control units 234 and 244 shown in FIG. 2.

Functions of elements of the virtual system shown in FIG. 3 are identical to those of the virtual system shown in FIG. 2, except for the difference described above, and thus a detailed description thereof will be omitted.

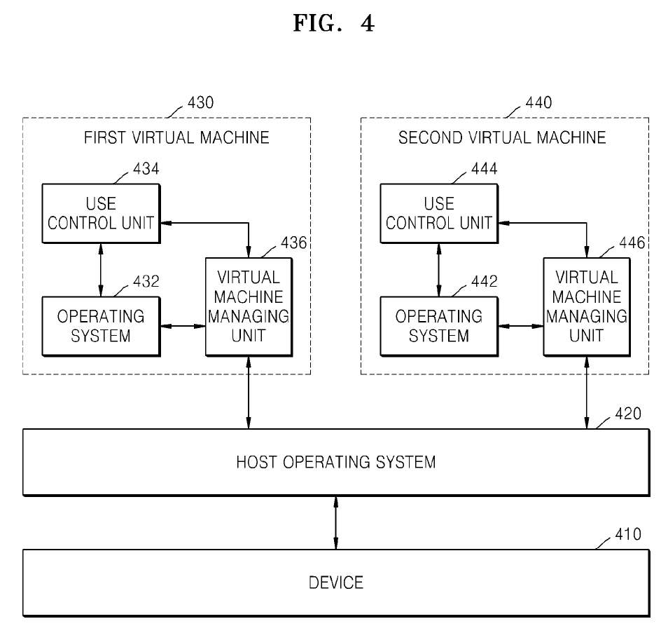

FIG. 4 shows a virtual system for restricting use of contents in a virtual machine according another exemplary embodiment of the present invention.

In the virtual system of FIG. 4, each of first and second virtual machines 430 and 440 includes a virtual machine managing unit (220 of FIG. 2), and the virtual system further includes a host operating system 420 for managing a virtual machine managing unit 436 included in the virtual machine 430 and a virtual machine managing unit 446 included in the virtual machine 440.

In this regard, the host operating system 420 reads the first device identifier from a device 410, transmits the first device identifier to the virtual machine managing unit 436 of the virtual machine 430 and the virtual machine managing unit 446 of the virtual machine 440, and manages the virtual machine managing units 436 and 446.

Here, the virtual machine managing units 436 and 446 read the second device identifier allocated to the operating systems 432 and 442, compare whether the first device identifier is identical to the second device identifier, and transmit the result of the comparison to the use control units 434 and 444.

However, the host operating system 420 may be omitted. If omitted, the virtual machine managing unit 436 of the virtual machine 430 and the virtual machine managing unit 446 of the virtual machine 440 read the first device identifier directly from the device 410.

That is, in FIG. 4, the virtual machine managing unit 436 of the virtual machine 430 and the virtual machine managing unit 446 of the virtual machine 440 only manage corresponding virtual machines 430 and 440, respectively.

Functions of elements of the virtual system shown in FIG. 4 are identical to those of the virtual systems shown in FIGS. 2 and 3, except for the difference described above, and thus a detailed description thereof will be omitted.

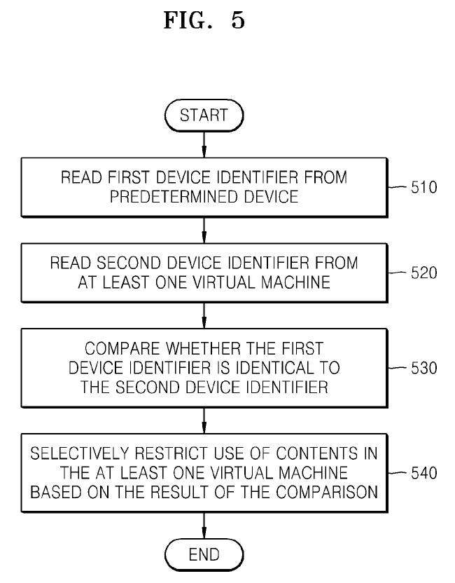

FIG. 5 is a flowchart of illustrating a method of restricting use of contents in a virtual system according to an exemplary embodiment of the present invention.

In operation 510, a first device identifier is read from a predetermined device in order to identify the device.

In operation 520, a second device identifier, which is a device identifier allocated to at least one virtual machine, is read from the at least one virtual device which is implemented in the device.

In operation 530, the read first device identifier is compared with the read second device identifier.

In operation 540, use of contents is selectively restricted in the at least one virtual machine based on the result of the comparison.

Meanwhile, exemplary embodiments of the present invention can be saved as programs executed in computers, and can be implemented in a general purpose digital computer in which the programs are operated using a computer-readable recording medium.

The computer-readable recording medium includes a storage medium such as: a magnetic recording medium such as a ROM, floppy disc, and hard disc; and an optical recognition medium such as a CD-ROM and digital versatile disk (DVD).

According to the present invention, use of contents in a virtual machine implemented in an unauthorized device can be restricted.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of restricting use of contents in a virtual system comprising at least one virtual machine implemented by a device, the method comprising:
reading a first device identifier from the device in order to identify the device;
reading a second device identifier, which is a device identifier allocated to the at least one virtual machine, from the at least one virtual machine;
determining whether the first device identifier is identical to the second device identifier; and
selectively restricting use of contents in the at least one virtual machine based on a result of the determining.

2. The method of claim 1, wherein the at least one virtual machine comprises an operating system and a use control unit which selectively restricts the use of the contents executed in the operating system,
wherein the virtual system further comprises a virtual machine managing unit which manages the at least one virtual machine, and
wherein the second device identifier is allocated to the operating system of the at least one virtual machine.

3. The method of claim 2, wherein the virtual machine managing unit is installed in the at least one virtual machine or in another virtual machine which does not comprise the operating system and the use control unit.

4. The method of claim 2, wherein the second device identifier is an identifier of the device which is allocated to the virtual machine before reading the first device identifier or an identifier of another device.

5. The method of claim 1, wherein the selectively restricting the use of the contents comprises:
generating a status flag which indicates whether the contents can be used based on the result of the determining; and
selectively restricting the use of the contents in the at least one virtual machine based on the status flag.

6. The method of claim 2, wherein the selectively restricting of use of contents comprises:
selectively transmitting, from the virtual machine managing unit, the second device identifier to the use control unit based on the result of the determining; and
selectively restricting, by the use control unit, the use of contents in the at least one virtual machine depending on whether the second device identifier is transmitted.

7. The method of claim 2, wherein the selectively restricting of the use of the contents comprises:
if a virtual machine is being newly operated in the device for the first time, determining whether the second device identifier is allocated to the use control unit of the newly operated virtual machine;
determining whether the second device identifier allocated to the use control unit is identical to the first device identifier, if it is determined that the second device identifier is allocated to the use control unit; and
selectively restricting operations of the operating system of the newly operated virtual machine according to a result of the determining whether the second device identifier allocated to the use control unit is identical to the first device identifier.

8. The method of claim 2, wherein the selectively restricting of the use of the contents comprises:
periodically determining whether the second device identifier is allocated to the use control unit of the at least one virtual machine;
comparing the second device identifier allocated to the use control unit with the first device identifier if it is determined that the second device identifier is allocated to the use control unit; and
selectively restricting the use of the contents in the at least one virtual machine based on a result of the comparing.

9. The method of claim 2, wherein the virtual machine further comprises at least one selected from the group consisting of user authentication information for authenticating a user who wants to use the contents executed in the virtual machine, use restriction information for restricting the use of the contents, and integrity validation information for detecting tampering with regard to the user authentication information and the use restriction information.

10. The method of claim 9, further comprising:
detecting tampering with regard to the user authentication information and the use restriction information based on the integrity validation information; and
performing authentication of the user based on the user authentication information if it is detected that the user authentication information and the use restriction information are not tampered with,
wherein the selectively restricting of the use of the contents is performed based on a result of the authentication and the use restriction information.

11. A virtual system for restricting use of contents in at least one virtual machine implemented by a device, the virtual system comprising:
at least one virtual machine comprising an operating system and a use control unit which selectively restricts use of contents executed in the operating system; and
a virtual machine managing unit which manages the at least one virtual machine,
wherein the virtual machine managing unit reads a first device identifier from the device in order to identify the device, reads a second device identifier allocated to the at least one virtual machine from the at least one virtual machine, determines whether the first device identifier is identical to the second device identifier, and controls the control unit to selectively restrict the use of the contents in the at least one virtual machine based on the result of the determination.

12. The virtual system of claim 11, wherein the virtual machine managing unit is installed in the at least one virtual machine or in another virtual machine which does not comprise the operating system and the use control unit, and the second device identifier is allocated to the operating system of the at least one virtual machine.

13. The virtual system of claim 11, wherein the second device identifier is an identifier of the device which is allocated to the virtual machine before reading the first device identifier or an identifier of another device.

14. The virtual system of claim 11, wherein the virtual machine managing unit generates a status flag which indicates whether the contents can be used based on the result of the determination, and transmits the status flag to the use control unit, and
the use control unit selectively restricts the use of the contents in the at least one virtual machine based on the status flag which is transmitted.

15. The virtual system of claim 11, wherein the virtual machine managing unit selectively transmits the second device identifier to the use control unit based on the result of the determination, and
the use control unit selectively restricts the use of contents in the at least one virtual machine depending on whether the second device identifier is transmitted.

16. The virtual system of claim 11, wherein, if a virtual machine is newly operated in the device for the first time, the virtual machine managing unit determines whether the second device identifier is allocated to the use control unit of the newly operated virtual machine, determines whether the second device identifier allocated to the use control unit is identical to the first device identifier if it is determined that the second device identifier is allocated to the use control unit, and transmits to the use control unit a result of the determination of whether the second device identifier allocated to the use control unit is identical to the first device identifier, and
the use control unit selectively restricts operations of the operating system of the newly operated virtual machine based on the result of the determination of whether the second device identifier allocated to the use control unit is identical to the first device identifier.

17. The virtual system of claim 11, wherein the virtual machine managing unit periodically determines whether the second device identifier is allocated to the use control unit of the at least one virtual machine, compares the second device identifier allocated to the use control unit with the first device identifier if it is determined that the second device identifier is allocated to the use control unit, and transmits a result of the comparison to the use control unit, and
the use control unit selectively restricts the use of the contents in the at least one virtual machine based on the result of the comparison by the virtual machine managing unit.

18. The virtual system of claim 11, wherein the virtual machine further comprises at least one selected from the group consisting of user authentication information for authenticating a user who wants to use the contents executed in the virtual machine, use restriction information for restricting the use of the contents, and integrity validation information for detecting tampering with regard to the user authentication information and the use restriction information.

19. The virtual system of claim 18, wherein the virtual machine managing unit detects tampering with regard to the user authentication information and the use restriction information based on the integrity validation information, performs authentication of the user based on the user authentication information if it is detected that the user authentication information and the use restriction information are not tampered with, and transmits a result of the authentication to the use control unit, and
the use control unit selectively restricts the use of the contents based on the result of authentication and the use restriction information.

20. A computer-readable recording medium having recorded thereon a program for executing the method of claim 1.
